(19) United States
(12) Patent Application Publication
(10) Pub. No.: US 2025/0179837 A1
(43) Pub. Date: Jun. 5, 2025

(54) APPARATUS AND METHODS FOR SECURING AN EQUIPMENT CABINET

(71) Applicant: Hoffman Enclosures Inc., Anoka, MN (US)

(72) Inventors: Rony Khalife, Coon Rapids, MN (US); Kevin Roof, St. Louis Park, MN (US)

(21) Appl. No.: 19/049,377

(22) Filed: Feb. 10, 2025

Related U.S. Application Data
(63) Continuation of application No. 17/857,355, filed on Jul. 5, 2022, now Pat. No. 12,221,810.
(60) Provisional application No. 63/220,065, filed on Jul. 9, 2021.

(51) Int. Cl. E05B 57/00; E05B 1/00

(52) U.S. Cl. CPC E05B 57/00; E05B 1/0007

(57) ABSTRACT

An equipment cabinet can include a cabinet section and a door supported by the cabinet section to be movable between an open orientation and a closed orientation. A door lock can be movable to a locked orientation to lock the door to the cabinet section, with the door in the closed orientation. A securing assembly that is coupled to the cabinet section can include a handle and a body. The door lock, in the locked orientation to lock the door to the cabinet section, can engage the body to block movement of the handle between the engaged orientation and the free orientation.

### CROSS-REFERENCE TO RELATED APPLICATIONS

This application is a continuation of U.S. Non-Provisional application Ser. No. 17/857,355, filed Jul. 5, 2022, which claims priority to and incorporates by reference U.S. Provisional Application No. 63/220,065, filed Jul. 9, 2021, both titled “Apparatus and Methods for Securing an Equipment Cabinet.”

### BACKGROUND

Equipment cabinets, for example equipment cabinets for housing network ports and cabling, can have sections that are hingedly coupled to allow easy access to the inner portion of the electrical cabinet. It is sometimes preferable to secure the hinged sections of an equipment cabinet together. This can be done to prevent access to the equipment cabinet and/or to prevent accidental opening.

### SUMMARY

Some embodiments of the invention can provide a securing assembly for locking together a first section and a second section of an equipment cabinet against hinging movement of the cabinet. The first section can hingedly support a door of the cabinet. The securing assembly can include a knob, with a pocket, and a latch can be coupled to the knob to be rotated by the knob as the securing assembly is rotated between a free orientation and an engaged orientation. The knob can be coupled to and rotatable relative to the first section. With the securing assembly in the free orientation, the latch can be disengaged from the second section to permit the first section to hingedly open away from the second section. With the securing assembly in the engaged orientation, the latch can be engaged with the second section to lock the first and second sections together and the pocket of the knob can be oriented to receive an arm of a lock on the door of the equipment cabinet as the lock is moved from an unlocked orientation to a locked orientation, to lock the door to the first section and lock the securing assembly in the engaged orientation.

Some embodiments of the invention can provide an electrical cabinet including a first section, a second section hingedly coupled to the first section, a door hingedly coupled to the first section opposite the second section, a securing assembly rotatable from a free orientation, in which the first and second sections can be hinged open, to an engaged orientation, in which the securing assembly releasably locks the first section closed with the second section, and a door lock rotatable from an open orientation to a locked orientation, when the securing assembly is in the engaged orientation, to lock the door closed with the door covering the securing assembly. In the locked orientation, the door lock can also lock the securing assembly against rotation from the engaged orientation to the free orientation.

Some embodiments of the invention can provide a securing assembly for locking together a first section and a second section of an equipment cabinet. The equipment cabinet further include a door with a door lock to secure the door relative to the first section. The securing assembly can include a knob that includes a handle configured to be outside of the first section when installed and a body that extends from the handle and is configured to be rotatable inside of the first section when installed. The body can include one or more pockets configured to receive the door lock to secure the knob against rotation and a latch configured to be rotated from a disengaged orientation to an engaged orientation to lock the first and second sections together. The latch can be coupled to the knob so as to rotate with the knob relative to the first and second sections when installed.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a top front right isometric view of an electrical cabinet in which a securing assembly according to an embodiment of the invention is provided;

FIG. 2 is a partial top front left isometric view of the electrical cabinet of FIG. 1 with engagement assemblies according to a conventional system;

FIG. 3 is a partial top front right isometric view of an engagement assembly of the system of FIG. 2;

FIG. 4 is top front right isometric view of the electrical cabinet of FIG. 1 with a front door opened exposing a knob of the securing assembly according to an embodiment of the invention;

FIG. 5 is a top front left isometric view of the electrical cabinet of FIG. 1 with the door removed;

FIG. 6 is a top front right side isometric view of the electrical cabinet of FIG. 1 with a first section shown disengaged from a second section;

FIG. 7 is a top front right isometric view of a knob from the securing assembly according to an embodiment of the invention;

FIG. 8 is a top rear left isometric view of the knob of FIG. 7;

FIG. 9 is a right side elevation view of the knob of FIG. 7;

FIG. 10 is a top plan view of the knob of FIG. 7;

FIG. 11 is a top rear left isometric view of the securing assembly according to an embodiment of the invention.

FIG. 12 is a top rear left isometric view of the securing assembly of FIG. 11 in the first section of the electrical cabinet of FIG. 1 according to an embodiment of the invention in a disengaged orientation;

FIG. 13 is a top rear left isometric view of the securing assembly of FIG. 11 in the first section of the electrical cabinet of FIG. 1 in an engaged orientation; and

FIG. 14 is top rear left isometric view of the securing assembly of FIG. 11 in the first section of the electrical cabinet of FIG. 1 in an engaged orientation and locked in position by a lock on the front door of the electrical cabinet.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Unless otherwise specified or limited, the terms “about” and “approximately,” as used herein with respect to a reference value, refer to variations from the reference value of ±15% or less (e.g., ±10%, ±5%, etc.), inclusive of the endpoints of the range. Similarly, the term “substantially equal” (and the like) as used herein with respect to a reference value refers to variations from the reference value of less than ±30% (e.g., ±20%, ±10%, ±5%) inclusive. Where specified, “substantially” can indicate in particular a variation in one numerical direction relative to a reference value. For example, “substantially less” than a reference value (and the like) indicates a value that is reduced from the reference value by 30% or more, and “substantially more” than a reference value (and the like) indicates a value that is increased from the reference value by 30% or more.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Some of the discussion below describes a securing assembly that can be used to releasably secure sections of an equipment cabinet together. An equipment cabinet can be a cabinet used to store Datacom/Telecom equipment including, for example, routers, splitters, patch panels, etc., and/or cables. Some equipment cabinets have a first/front section and a second/rear section, wherein the first section houses much of the equipment and the second section provides entry and exit points for the cables. The securing assembly can increase the security of the equipment cabinet and reduce the potential for accidental or purposeful tampering with the equipment or cables housed therein. The securing assembly can also simplify joining and separating the first and second sections for those with the authority to do so. The context and particulars of this discussion are presented as examples only. For example, embodiments of the disclosed invention can be used in other contexts, such as for cabinets or other installations having movable sections and can be configured in various ways, including with other shapes and arrangements of elements.

When Datacom/Telecom systems are installed, a cabinet can be installed as a hub, or termination point for multiple network cables. Due to the reliability and security requirements of many such systems, the cabinet is preferably lockable so that the interior is inaccessible to those without the proper authority. Many cabinets come with a lockable front door for added security. However, due to the amount of cabling and equipment housed within a cabinet, having access to the point of entry/exit of the cables and to the back of the equipment housed within the cabinet can be advantageous when it comes to installation or modification of the system. To provide such access, the cabinet can have hinged sections, wherein, for example, one section houses the equipment and another section is the entry/exit point for the cables. To maintain the security of the cabinet, the sections can be releasably secured together. It would be useful to ensure that the assembly used to secure the sections together is easy to operate, does not interfere with any of the cabling or equipment stored within the cabinet, and remains inaccessible when the front door of the cabinet is closed. The potential for unwanted tampering by accessing the cabinet by separating the sections increases if the securing system is accessible when the front door is closed.

Conventional arrangements for securing the connection between relatively movable sections of an equipment cabinet can include multiple engagement systems that can be accessed when the front door of the cabinet is open, but must be accessed by reaching a hand into the cabinet and rotating a handle (see Reference Art discussion below). This can increase the potential for accidentally contacting the equipment and possibly disturbing the electrical connections. Further, there is also potential for the internal handles to be accessed and manipulated through vent slots in the side of the cabinet.

Embodiments of the invention can address these or other issues by providing a secure connection between movable sections of an equipment cabinet. For example, in some embodiments, a securing assembly can include a knob that is accessible external to a front section of the cabinet and the equipment space within the cabinet, but only after the front door of the cabinet is opened. The knob can be coupled to a latch that is engageable with a rear section of the cabinet, which can be disengaged by rotating the knob a quarter turn (e.g., generally, according to a wide variety of known quarter-turn latch mechanisms) or by other degree of rotation (e.g., generally also according to a wide variety of other rotatable latch mechanisms). Further, the securing assembly may be locked in an engaged orientation with a lock on the front door used to also lock the front door. Therefore, even if the securing system is accessed via vents in the side of the cabinet, the securing assembly would be unable to rotate and disengage the front section from the rear section because it is also engaged with the lock on the front door.

In some embodiments, the knob of the securing assembly can include retaining tabs that, once the knob is installed on the cabinet, prevent the knob from being removed from the cabinet. In some cases, the knob must be oriented in an installation orientation to be installed within or removed from the cabinet, but after installation, the latch prevents the knob from returning to the installation orientation. For example, a set of pegs on the latch can be configured to follow a respective set of slots in a section of the front panel adjacent the second section, and the set of pegs can prevent rotation beyond a predetermined angular distance.

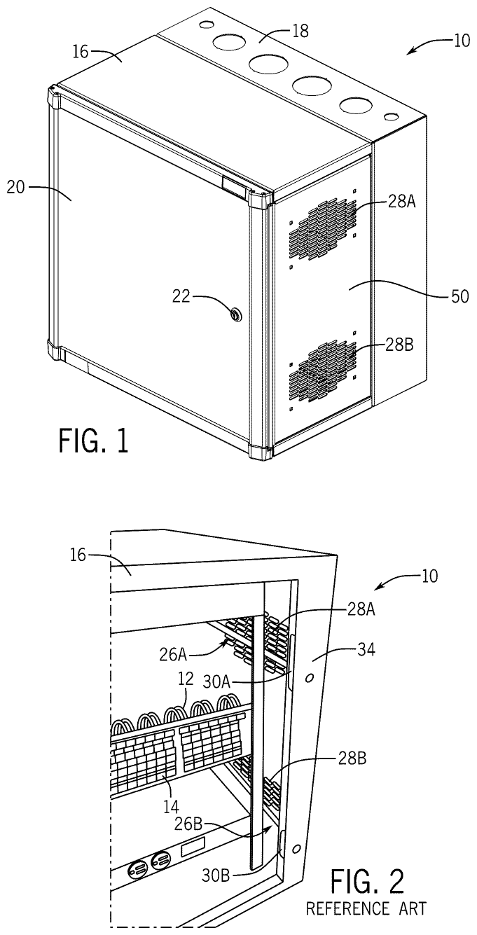

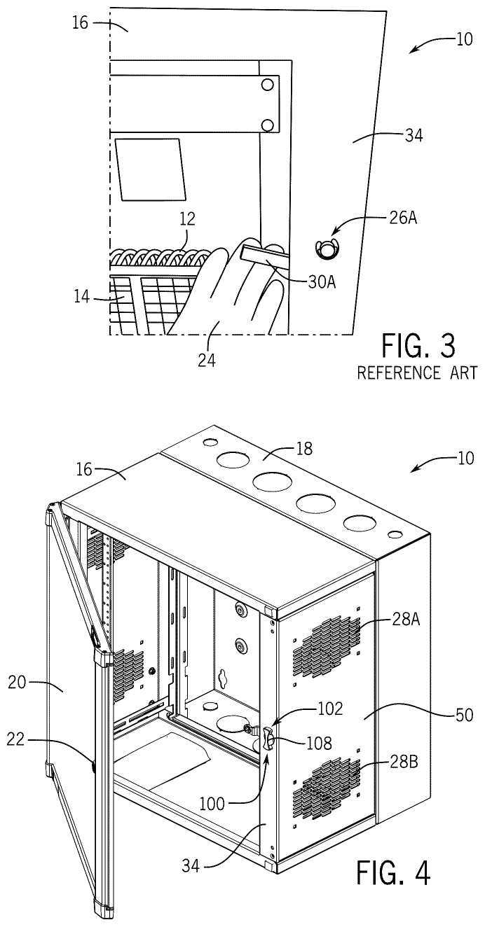

FIG. 1 illustrates an electrical cabinet 10 for housing electrical components, for example, network cables 12 and ports 14 (shown in FIGS. 2 and 3). The electrical cabinet 10 has a first section 16 that is hingedly attached to a second section 18 and has a front door 20 that can be locked to the first section 16 with a lock 22. Typically, the first and second sections 16, 18 are separable to allow case of access during installation or servicing of the electrical components 12, 14. A operator 24 (shown in FIG. 3) can access the first section 16 of the electrical cabinet 10 by unlocking the front door 20 after disengaging the lock 22 from the first section 16, thereby permitting the operator 24 access to the first section 16. However, access to the second section 18 remains limited. The second section 18 can be where many of the network cables enter and exit the electrical cabinet and also where the mounting fasteners (not shown) for fastening the electrical cabinet 10 to a structure are located. Therefore, it can be advantageous to have easy access to the second section 18, for example, from the front of the electrical cabinet 10.

In some conventional electrical cabinets (shown in FIGS. 2 and 3), first and second sections can be releasably engaged to each other with a set of engagement assemblies 26A, 26B accessible from the front section 16. The set of engagement assemblies 26A, 26B are located in the top third and the bottom third of the first section 16 of the electrical cabinet 10 and extend from the front of the first section 16, alongside a set of vents 28 (for example, as shown, a first vent 28A and a second vent 28B) spaced vertically within side walls 50 of the first section 16, and through the back of the first section 16 where they can engage the second section 18. The engagement assemblies 26A, 26B can have handles 30A, 30B that are rotatable to release the engagement between the first and second sections 16, 18. The handles 30A, 30B are located within the first section 16, requiring a operator 24 to reach within the first section 16 to grab and rotate the handles 30A, 30B downward in front of the electrical components 12, 14 to disengage the first section 16 from the second section 18.

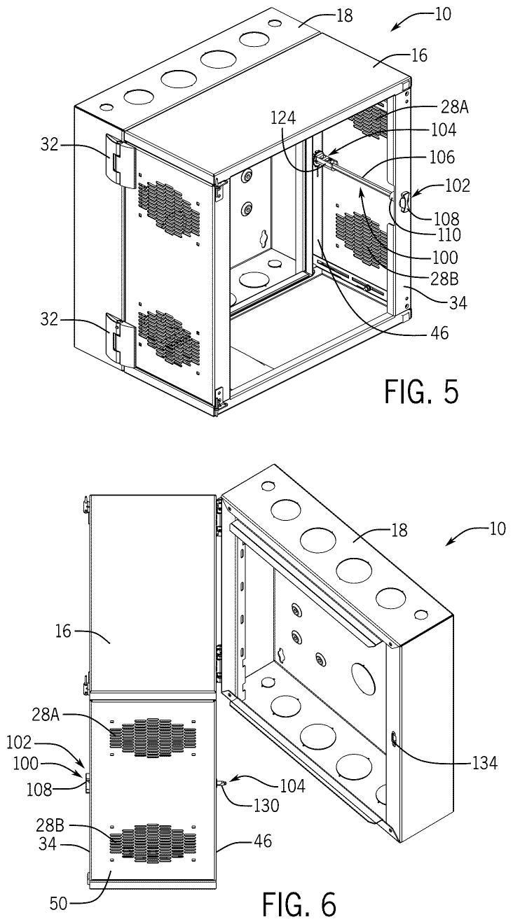

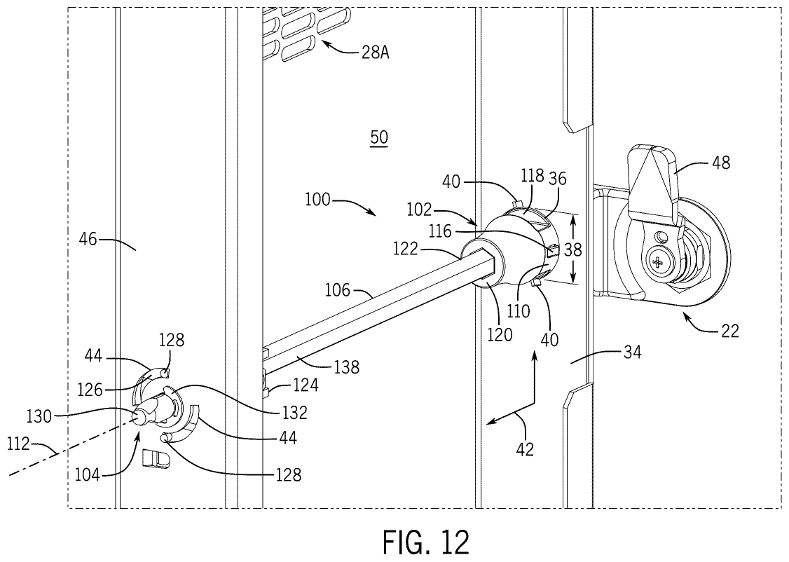

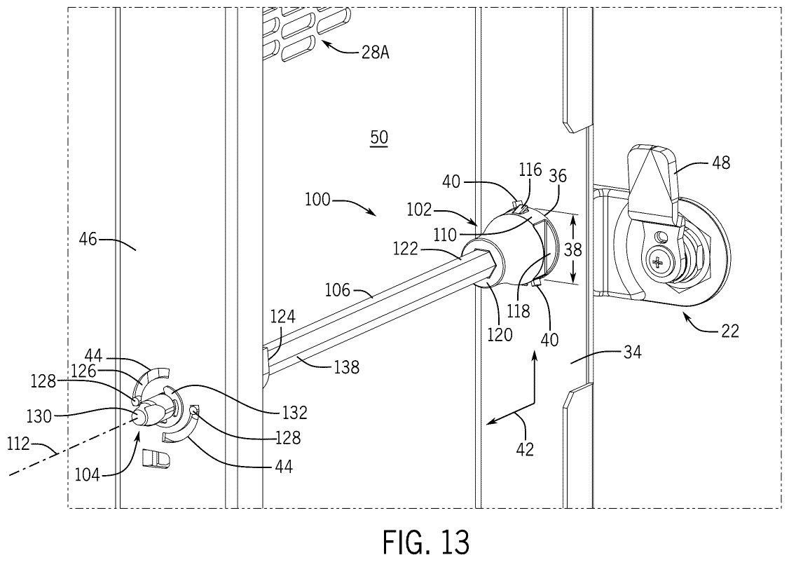

FIGS. 4 through 6 show the electrical cabinet 10 with a securing assembly 100 according to an embodiment of the invention. FIG. 4 shows the electrical cabinet 10 with the front door 20 open and the first and second sections 16, 18 secured together by the securing assembly 100 in an engaged orientation (see also FIG. 13). FIG. 5 illustrates the electrical cabinet 10 with the front door 20 removed to provide a better view of the securing assembly 100 within the first section 16 in the engaged orientation. As shown in FIG. 5, the securing assembly 100 includes a knob 102, a latch 104, and a connecting rod 106 extending between the knob 102 and the latch 104. The securing assembly 100 is positioned between the cabinet vents 28 (i.e., the connecting rod 106 does not obstruct any part of the cabinet vents 28). FIG. 6 shows the first section 16 released from the second section 18 and rotated therefrom about hinges 32 with the securing assembly 100 in a disengaged, or free, orientation (see also FIG. 12).

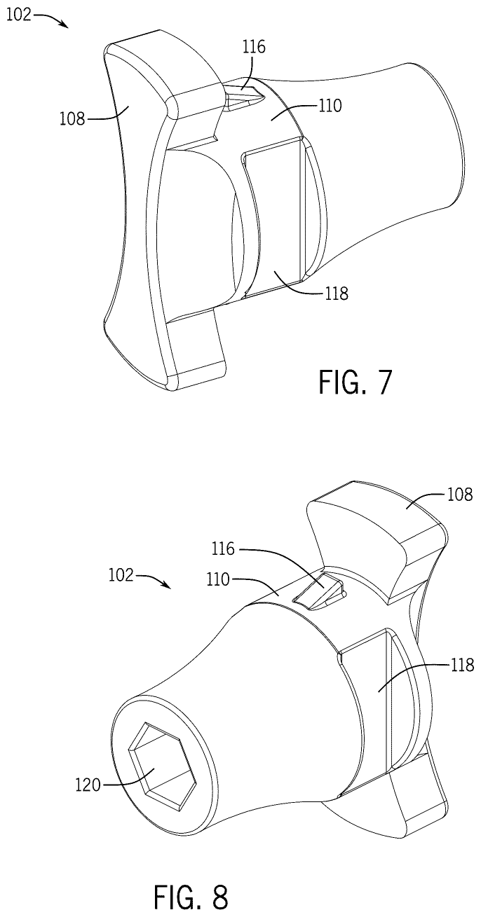

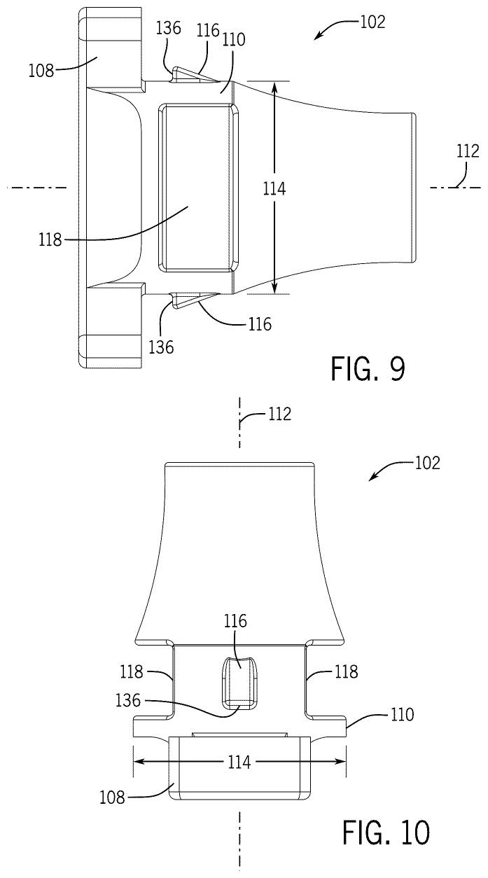

Looking to FIGS. 7 through 10, the knob 102 of the securing assembly 100 is shown in various views in isolation. The knob 102 has a handle 108 and a shaft 110 extending from the handle 108 along a shaft axis 112 (shown in FIGS. 9 and 10). In some embodiments, as shown here, the handle 108 and the shaft 110 can be integrally formed. However, in some embodiments the handle 108 and the shaft 110 can be distinct pieces coupled together, for example, with a fastener (not shown). The shaft 110 has a shaft diameter 114 (shown in FIGS. 9 and 10), a set of retaining tabs 116 extending outwardly and oppositely from a periphery of the shaft 110, and at least one pocket (here shown as a set of pockets 118) extending inwardly and oppositely from the periphery of the shaft 110 in a direction perpendicular from the shaft axis 112. In some embodiments, the pockets 118 are spaced equidistantly between the set of retaining tabs 116.

With reference to FIGS. 12 through 14, the knob 102 is configured to be received within a hole 36 within a first, front, panel 34 of the first section 16 of the electrical cabinet 10 in an installation orientation (not shown). The hole 36 is circular, with a hole diameter 38, and has a set of key slots 40. The set of key slots 40 extend outwardly from a periphery of the hole 36 and, in the illustrated example, include a pair of key slots oppositely disposed from each other. The set of key slots 40 are angularly offset from a vertical reference plane 42 extending vertically through the hole 36 from the bottom of the electrical cabinet 10 to the top of the electrical cabinet 10. The angular offset can be in the range of about 5 degrees to about 10 degrees. Or, as can be described with respect to the orientation of the hole 36 and the key slots 40 as shown in in FIG. 12, the key slots 40 can be located between about an 11 o'clock orientation and a 12 o'clock orientation and between about a 5 o'clock orientation and a 6 o'clock orientation on the hole 36.

Once installed, the knob handle 108 of the knob 102 is positioned and accessible from outside the first section 16 and the knob shaft 110 is positioned within the first section 16. The shaft diameter 114 of the knob shaft 110 is sized to be smaller than the hole diameter 38 so that during the installation of the knob 102 within the hole 36, the knob shaft 110 can be received at least partially through the hole 36, and the retaining tabs 116 are configured to be alignable with and receivable through the set of key slots 40. As shown in FIG. 13 in particular, once received within the hole 36, the knob 102 is rotated to position the retaining tabs 116 in alignment with the vertical reference plane 42 and thereby place the knob 102 in an engagement orientation. The retaining tabs 116 each include an abutment surface 136 (shown in FIGS. 9 and 10) configured to abut the inside of the first section 16 of the electrical cabinet 10 when the securing assembly 100 is moved (e.g., pulled) toward the first section 16. The retaining tabs 116 prevent the knob 102 from being pulled back through the hole 36 when the knob 102 is in ether the engagement orientation (shown in FIG. 13) or the free orientation (shown in FIG. 12).

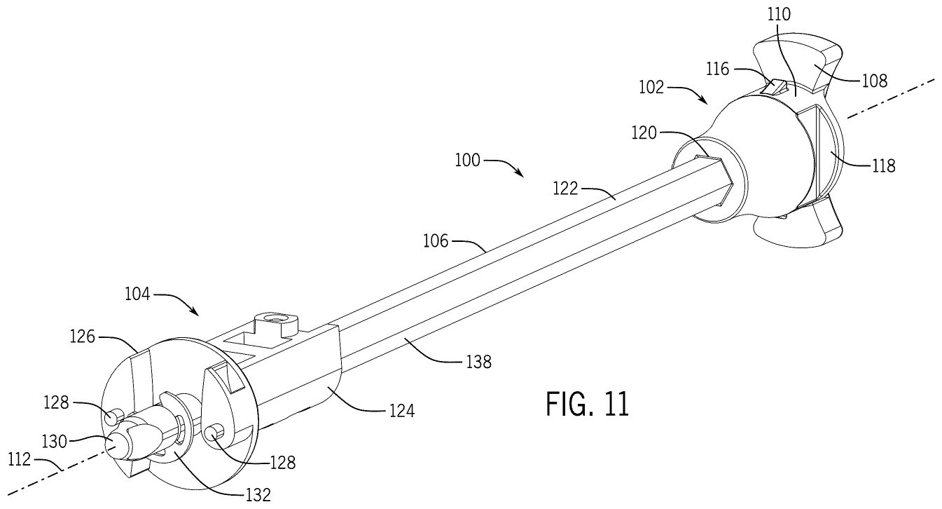

The knob 106 also includes a chamber 120 as shown in FIG. 8 in particular. The chamber 120 extends inward from an end of the knob 106 distal to the knob handle 108 and along the shaft axis 112. The chamber 120 is configured to receive a first end 122 of the connecting rod 106 (shown in FIG. 11). A second end 138 of the connecting rod 106 is received within a coupling 124 of the latch 104 (shown in FIG. 11), which can include a set screw (not shown) to secure the connecting rod 106 within the chamber 120 at a predetermined depth. Thereby, the knob 102 is operatively connected to the latch 104, and rotation of the knob 102 is directly translated to the latch 104 via the connecting rod 106.

The latch 104 can be seen in FIGS. 5 and 11 through 14. In addition to the coupling 124 described above, the latch 104 has a collar 126 with a set of pegs 128 and a barb 130 extending in a direction away from the coupling 124. The pegs 128 are angularly spaced 180 degrees from each other and are configured to be received within a set of slots 44, respectively, in a second, rear, panel 46 of the first section 16 of the electrical cabinet 10. The set of slots 44 are configured to provide an angular pathway along which the set of pegs 128 can travel to and between a disengaged (or free) orientation of the securing assembly 100 (shown in FIG. 12) and an engaged orientation (shown in FIG. 13), as further discussed below. The securing assembly 100 is therefore retained between the first and second panels 34, 46 of the first section 16 of the electrical cabinet 10, with the set of retaining tabs 116 limiting movement in the direction of the first panel 34 and the collar 126 limiting movement in direction of the second panel 46.

Further, the barb 130 extends from the collar 130 in the same direction as the set of pegs 128 and is configured to extend through the second panel 46. When the securing assembly 100 is assembled, the barb 130 is configured to extend coaxially with the shaft axis 112. The barb 130 is also configured to be removably engageable with a retainer 134 in the second section 18 of the electrical cabinet 10 (see FIG. 6), whereby engagement and disengagement of the barb 130 and the retainer 134 are dependent on the rotational orientation of the knob 102, as further discussed below.

Additionally or alternatively, in some embodiments, as shown here, a snap ring 132 can be attached to the barb 130 proximal to the collar 126 but configured to be on the opposite side of the second panel 46 of the first section 16 when the securing assembly 100 is installed. The snap ring 132 can limit movement of the securing assembly 100 along the shaft axis 112 and can further add to the security of the securing assembly 100 by making it more difficult to remove the knob 102 from the front door side of the electrical cabinet 10.

In FIG. 12, the securing assembly 100 is in the free orientation. In the free orientation, the barb 130 is not engaged with the retainer 134 and the first section 16 is accordingly movable relative to the second section 18. With the knob 102 oriented as shown in FIG. 12, the set of retaining tabs 116 are oriented in the 3 o'clock and 9 o'clock positions and the pockets 118 are oriented in the 12 o'clock and 6 o'clock positions. Further, the set of pegs 128 are at terminal ends of the respective slots 44 and are oriented in the 12 o'clock and 6 o'clock positions, respectively. In this orientation, the barb 130 is configured to urge the retainer 134 (shown in FIG. 6) open to accept the barb 130 therein when joining the first and second sections 16, 18.

In FIG. 13, starting from the orientation shown in FIG. 12, the knob 102 has been rotated clockwise 90 degrees, as viewed from the perspective of the securing assembly 100 as shown in FIG. 4 (and counterclockwise from the perspective of FIG. 13), to place the securing assembly 100 in the engaged orientation. With the knob 102 oriented as shown in FIG. 13, the set of retaining tabs 116 are oriented in the 6 o'clock and 12 o'clock positions and the pockets 118 are oriented in the 3 o'clock and 9 o'clock positions. Additionally, the set of pegs 128 are at the opposite terminal ends of the respective slots 44 as compared to the free orientation shown in FIG. 12 and are now oriented in the 3 o'clock and 9 o'clock positions. In this orientation, the barb 130 is configured to engage the retainer 134 (shown in FIG. 6) and prevent the separation of the first and second sections 16, 18 of the electrical cabinet 10. It should be noted, that the set of key slots 40 are located just beyond the location of the retaining tabs 116 of the knob 102 when the securing assembly 100 is in the engagement orientation. In this location, even if the operator 24 is able to continue turning the knob 102 in the clockwise direction to align the retaining tabs 116 with the key slots 40, the barb 130 remains engaged with the retainer 134 to prevent removal of the securing assembly 100 from the electrical cabinet 10. Further, the set of slots 44 are configured to only allow rotation of the knob 102 between the free orientation (shown in FIG. 12) and the engaged orientation (shown in FIG. 13), thus preventing further rotation of the knob 102 back to the installation orientation.

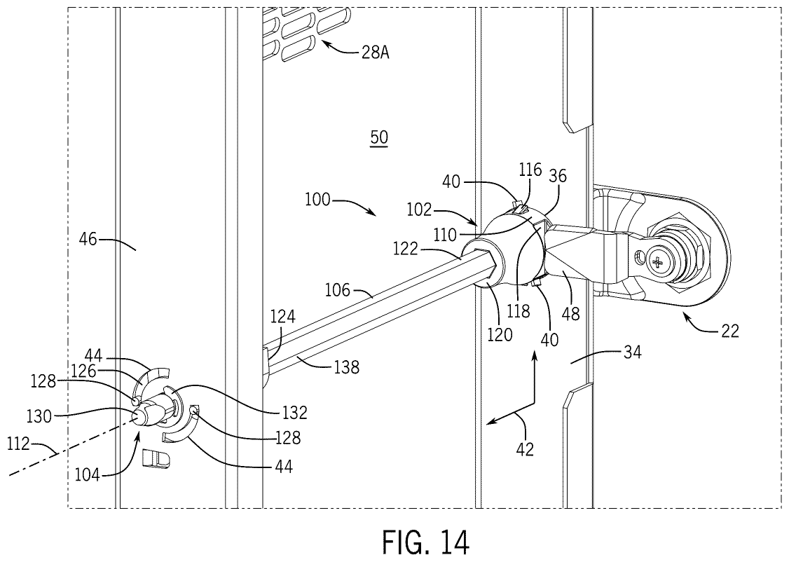

FIG. 14 illustrates the front door lock 22 engaged with the knob 102 when the securing assembly 100 is in the engagement orientation. The front door lock 22 has an arm 48 movable between an unlocked position (shown in FIG. 13) and a locked position (shown in FIG. 14). As shown in FIG. 14, the arm 48 of the lock 22 is in the locked position and received within the nearest pocket of the set of pockets 118. In addition to the arm 48 preventing the front door 20 from being opened through the engagement with the pocket 118, the arm 48 also prevents rotation of the knob 102. Additionally, or alternatively, as shown in FIG. 1, the design of the front door 20 is such that the front door 20 covers the knob 102 when closed, adding an additional layer of security.

In some implementations, devices or systems disclosed herein can be utilized or installed using methods embodying aspects of the invention. Correspondingly, description herein of particular features or capabilities of a device or system is generally intended to inherently include disclosure of a method of using such features for intended purposes and of implementing such capabilities. Similarly, express discussion of any method of using a particular device or system, unless otherwise indicated or limited, is intended to inherently include disclosure, as embodiments of the invention, of the utilized features and implemented capabilities of such device or system.

For example, with reference to FIGS. 12 through 14, some embodiments can include a method by which a operator can secure a connection between the first section 16 and the second section 18 of the electrical cabinet 10. To secure the connection, with the securing assembly 100 in the free orientation (e.g., as shown in FIG. 12), the operator 24 urges the first section 16 against the second section 18 so that the barb 130 is received within the retainer 134. The operator 24 then rotates the knob 102, and thus the latch 104, from the free orientation to the engaged orientation (e.g., as shown in FIG. 13) to engage the barb 130 with the retainer 134. In some embodiments, the operator 24 can further lock the electrical cabinet 10 by closing the front door 20 thereby covering the knob 102 and turning the front door lock 22 of the front door 20 to engage the arm 48 of the lock 22 with, and be received within, the pocket 118 in the knob shaft 110 (e.g., as shown in FIG. 14).

To release the first section 16 from the second section 18, the operator 24 rotates the arm 48 of the lock 22 out of the pocket 118, opens the front door 20, rotates the knob 102, and thus the latch 104, from the engaged orientation to the free orientation, and pulls the first section 16 apart from the second section 18, removing the barb 130 from the retainer 134.

Thus, embodiments of the invention can provide improved securement of the connection between a first section and a second section of an electrical cabinet. In some embodiments, for example, a securing assembly can include a knob that can be covered by a front door and that can engage with a door lock to more securely retain the engagement of the first and second sections.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

What is claimed is:

1. An equipment cabinet comprising:
a cabinet section;
a door hingedly supported by the cabinet section to be movable between an open orientation and a closed orientation, the door including a door lock with an arm that is movable from an unlocked orientation to a locked orientation to secure the door, relative to the cabinet section, in the closed orientation; and
a securing assembly supported by the cabinet section, the securing assembly including:
a handle that extends outside of the cabinet section to be covered by the door in the closed orientation and uncovered by the door in the open orientation; and
a body that extends from the handle to inside of the cabinet section and is rotatable, by rotation of the handle from outside of the cabinet section, between a first orientation and a second orientation;
the arm of the door lock:
in the locked orientation, blocking rotation of the body from the second orientation to the first orientation; and
in the unlocked orientation, permitting rotation of the body from the second orientation to the first orientation.

2. The equipment cabinet of claim 1, wherein the body includes a recessed area; and
wherein the arm, in the locked orientation, extends into the recessed area to block rotation of the body from the second orientation to the first orientation.

3. The equipment cabinet of claim 2, wherein the recessed area of the body is positioned within the cabinet section.

4. The equipment cabinet of claim 1, wherein the cabinet section is a first cabinet section that is hingedly coupled to a second cabinet section.

5. The equipment cabinet of claim 4, wherein, with the body in the first orientation, the first cabinet section is hingedly movable relative to the second cabinet section; and
wherein, with the body in the second orientation, the securing assembly locks the first cabinet section against hinged movement relative to the second cabinet section.

6. The equipment cabinet of claim 1, wherein the cabinet section is a first cabinet section and the securing assembly further includes a latch operably coupled to the body; and
wherein, with the body in the second orientation, the latch secures the first cabinet section relative to a second cabinet section.

7. The equipment cabinet of claim 6, wherein rotation of the body directly rotates the latch.

8. The equipment cabinet of claim 1, wherein tabs extend from the body within the cabinet section, the tabs engaging an interior surface of the cabinet section in the second orientation to secure the body to the cabinet section.

9. The equipment cabinet of claim 8, wherein engagement between the tabs and the interior surface of the cabinet section blocks axial removal of the handle from the cabinet section.

10. The equipment cabinet of claim 9, wherein, with the arm in the unlocked orientation, the body is rotatable from the second orientation to a third orientation by rotation of the handle; and
wherein the body is axially removable from the cabinet section in the third orientation.

11. The equipment cabinet of claim 1, wherein the arm of the door lock, in the locked orientation, secures the door in the closed orientation to block a front access opening of the cabinet section.

12. An equipment cabinet comprising:
a cabinet section;
a door supported by the cabinet section to be movable between an open orientation and a closed orientation;
a door lock that is movable to a locked orientation to lock the door to the cabinet section, with the door in the closed orientation; and
a securing assembly that is coupled to the cabinet section and includes:
a handle positioned to be covered by the door when the door is in the closed orientation and uncovered by the door when the door is in the open orientation, the handle being rotatable relative to the cabinet section, between a free orientation and an engaged orientation;
the door lock, in the locked orientation to lock the door to the cabinet section, engaging the securing assembly to block movement of the handle between the engaged orientation and the free orientation.

13. The equipment cabinet of claim 12, wherein the door lock is rotatable to the locked orientation; and
wherein the handle is rotatable, separately from the door lock, between the engaged orientation and the free orientation.

14. The equipment cabinet of claim 13, wherein the securing assembly further includes a body extending from the handle to inside the cabinet section; and
wherein the door lock engages the body inside of the cabinet section to block movement of the handle.

15. A method of securing an equipment cabinet, the method comprising:
moving a door to a closed orientation relative to a cabinet section, so that the door covers a handle of a securing assembly that is secured to the cabinet section, the handle being movable relative to the cabinet section between a free orientation and an engaged orientation; and
after moving the door to the closed orientation, operating a door lock secured to the door so that the door lock:
locks the door to the cabinet section in the closed orientation, with the door covering the handle; and
engages the securing assembly to block movement of the handle between the free and engaged orientations.

16. The method of claim 15, further comprising:
operating the door lock to:
unlock the door for movement from the closed orientation to an open orientation, to uncover the handle; and
disengage from the body of the securing assembly, to allow rotation of the handle relative to the cabinet section.

17. The method of claim 15, wherein operating the door lock includes rotating an arm to lock the door and engage the securing assembly.

18. The method of claim 17, wherein the arm blocks rotation of a body inside of the cabinet section to block movement of the handle from the engaged orientation to the free orientation.

19. The method of claim 18, wherein the arm rotates on a different axis than the body.

20. The method of claim 15, wherein the handle extends within a front opening of the cabinet section that provides access to inside of the cabinet section; and
wherein the door, in the closed orientation, blocks access to the inside of the cabinet section via the front opening.
